(19) United States
(12) Patent Application Publication
(10) Pub. No.: US 2012/0170593 A1
(43) Pub. Date: Jul. 5, 2012

(54) SYSTEM INCLUDING CHIPS, INTEGRATED CIRCUIT CHIP, AND METHOD FOR TRANSMITTING DATA PACKET

(76) Inventor: Seung-Min OH, Gyeonggi-do (KR)

(21) Appl. No.: 13/334,032

(22) Filed: Dec. 21, 2011

(30) Foreign Application Priority Data
Dec. 30, 2010 (KR) 10-2010-0138888

(51) Int. Cl. H04J 3/00

(52) U.S. Cl. 370/464

(57) ABSTRACT

A method for transmitting a data packet includes transmitting the data packet at a first frequency during an initial period for transmitting the data packet and transmitting the data packet at a second frequency different from the first frequency after the initial period.

### CROSS-REFERENCE TO RELATED APPLICATIONS

The present application claims priority of Korean Patent Application No. 10-2010-0138888, filed on Dec. 30, 2010, which is incorporated herein by reference in its entirety.

### BACKGROUND

1. Field

Exemplary embodiments of the present invention relate to data transmission between integrated circuit chips.

2. Description of the Related Art

A variety of integrated circuit chips do not operate by themselves, but operate while transmitting and receiving data to and from surrounding chips. For example, memory chips such as DRAM and Flash transmit and receive data to and from a memory controller, and a CPU also transmits and receives data to and from various chips on a mother board. With the development of technology, the transmission speed of data has gradually increased. As the transmission frequency of data becomes high, a “data-eye” for recognizing data (for example, a time window for detecting data) gradually decreases.

In particular, when data packets are successively transmitted, the data eye for data transmitted at the initial stage is further reduced than that for subsequent data due to the influence of various noise or the like. For example, when a data packet having 100 data is successively transmitted, the data eye for recognizing 1˜3 data transmitted at the initial stage is smaller than that of subsequent 97 data, which may lead to failure in data recognition.

### SUMMARY

An embodiment of the present invention is directed to technology for preventing incorrect data recognition which may occur when the data eye size of data transferred at the initial stage, among data which are successively transferred, is reduced.

In accordance with an embodiment of the present invention, a method for transmitting a data packet includes: transmitting the data packet at a first frequency during an initial period for transmitting the data packet; and transmitting the data packet at a second frequency different from the first frequency after the initial period.

In accordance with another embodiment of the present invention, a system includes a first chip, a second chip, and a data channel between the first and second chips. When a first data packet is transferred from the first chip to the second chip through the data channel, the first chip may transmit the first data packet at a first frequency during an initial period of a transmission period for the first data packet and transmit the first data packet at a second frequency different from the first frequency after the initial period.

In accordance with still another embodiment of the present invention, an integrated circuit chip includes an internal circuit and a data output circuit configured to output a data packet of the internal circuit to a data pad. The data output circuit may output the data packet at a first frequency during an initial period of a transmission period for the data packet and output the data packet at a second frequency different from the first frequency after the initial period.

### BRIEF DESCRIPTION OF THE DRAWINGS

FIG. 1 is a configuration diagram of a system including first and second chips in accordance with an embodiment of the present invention.

FIGS. 2A and 2B are flow charts showing a data transmission method in accordance with the embodiment of the present invention.

FIG. 3 is a diagram illustrating a first chip and a second chip in detail.

FIGS. 4A and 4B are timing diagrams for transmission of a data packet from the first chip to the second chip in FIGS. 2 to 3.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

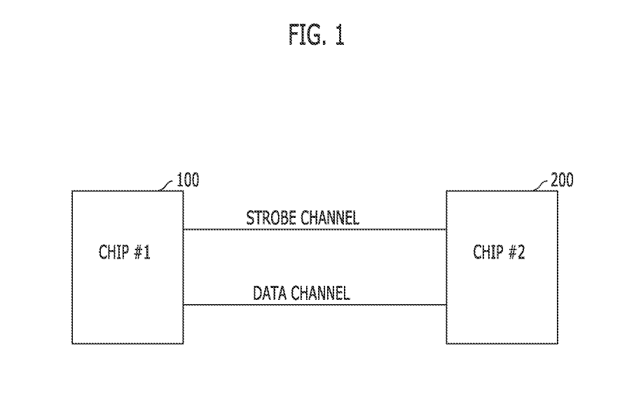

FIG. 1 is a configuration diagram of a system including first and second chips in accordance with an embodiment of the present invention.

Referring to FIG. 1, the system in accordance with the embodiment of the present invention includes a first chip 100, a second chip 200, a data channel DATA CHANNEL, and a strobe channel STROBE CHANNEL.

The first chip 100 and the second chip 200 refer to integrated circuit (IC) chips which transmit and receive data through the data channel DATA CHANNEL. The first and second chips 100 and 200 may include any IC chips such as a CPU, a graphic processer unit (GPU), DRAM, a flash memory, and a memory controller, which transmit and receive data.

The data channel DATA CHANNEL is a channel through which the first and second chips 100 and 200 transmit and receive data to and from each other. FIG. 1 illustrates that the system includes one data channel DATA CHANNEL, but the system may include a plurality of data channels DATA CHANNEL. For example, 32 data channels may be provided between a graphic DRAM and a GPU. On the other hand, and eight data channels may be provided between a flash memory and a flash controller.

The strobe channel STROBE CHANNEL is a channel through which a signal for strobing data transmitted to the data channel DATA CHANNEL is transmitted. The signal for strobing data may include a system clock signal. Instead of the system clock signal, a dedicated signal for strobing data may be used.

In this specification, a term such as a data packet is used. The data packet refers to a bundle of data which are successively transmitted through the data channel DATA CHANNEL. During a program (write) or read operation of a flash memory, about 500 data may be successively transmitted to one data channel DATA CHANNEL. In this case, 500 data compose a data packet. Furthermore, in the case of DRAM which operates with a burst length (BL) of eight, eight data are successively transmitted to one data channel DATA CHANNEL in response to one read command, and (the number of successively-applied read commands)*eight data are successively transmitted in response to the successively-applied read commands. In this case, (the number of successively-applied read commands)*eight data become the number of data composing one data packet.

As described above in the related art, when data are transmitted through a data channel, the data eye for recognizing data transmitted at the initial stage is further reduced than that of data transmitted subsequently. In this embodiment of the present invention, to address such a feature, when data are transmitted through the data channel, partial data are transmitted at a low speed during an initial period, and the other data are transmitted at high speed after the initial period.

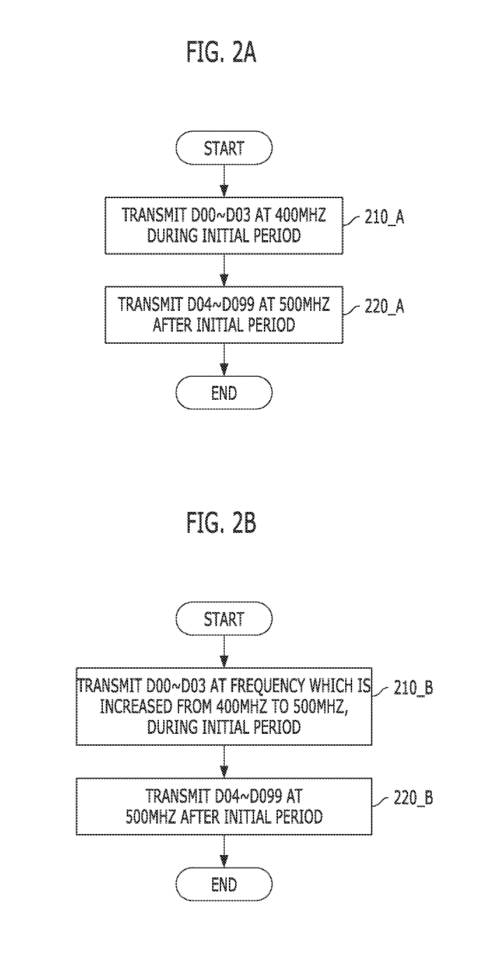

In accordance with the embodiment of the present invention, a method as shown in FIG. 2A may be used. In this method, partial data D00 to D03 among data D00 to D99 of a data packet may be transmitted at a low frequency of 400 MHz during an initial period of data packet transmission, at step S210_A, and the other data D04 to D99 may be transmitted at a high frequency of 500 Hhz after the initial period, at step S210_B. Alternatively, a method as shown in FIG. 2B may be used. In this method, partial data D00 to D03 among data D00 to D99 of a data packet may be transmitted at a frequency that gradually increases from 400 MHz to 500 MHz, during an initial period of data packet transmission (for example, 1˜5 cycles), at step S210_B, and the other data D04 to D99 may be transmitted at a high frequency of 500 MHz, which stays substantially constant, after the initial period, at step S220_B.

The method of FIG. 2A or 2B, in which the transmission speed of data during the initial period is differently set from the transmission speed of data after the initial period, may be used in both of the first and second chips 100 and 200 or used in any one of the first and second chips 100 and 200.

In FIGS. 2A and 2B, the number of data composing the data packet is set to 100 and four data are transmitted during the initial period. Furthermore, the low frequency is set to 400 MHz, and the high frequency is set to 500 MHz. However, the numerical values are only examples, and may be differently set depending on different design needs.

The length of the initial period may be set according to a period that the data eye is reduced during data packet transmission. For example, when 100 data are transmitted, the data eye may be reduced for two data transmitted at the initial stage. In this case, the length of the initial period may be set to a period during which two data are transmitted.

Furthermore, a difference between the high frequency and the low frequency may be set on the basis of a difference between the data eye size for recognizing data transmitted during the initial period and the data eye size for data transmitted after the initial period. For example, when the data eye size of the data transmitted during the initial period is smaller by 20% than that of the data transmitted after the initial period, the difference between the high frequency and the low frequency may be set to 20%.

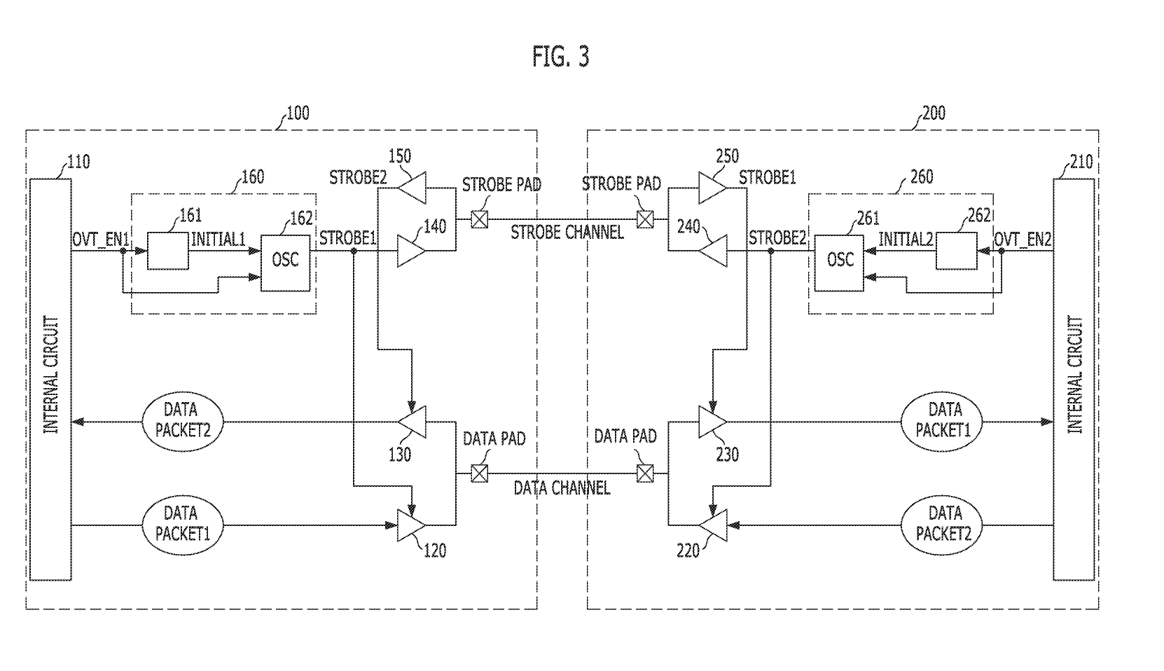

FIG. 3 is a diagram illustrating the first chip 100 and the second chip 200 in more detail.

Referring to FIG. 3, the first chip 100 includes an internal circuit 100, a data output circuit 120, a data input circuit 130, a strobe output circuit 140, a strobe input circuit 150, and a strobe signal generator 160.

The internal circuit 110 is configured to perform a unique function of the first chip 100. When the first chip 100 is a memory, the internal circuit 110 may include a circuit for storing data and a circuit for controlling the circuit. When the first chip 100 is a CPU, the internal circuit 100 may include a circuit for performing various operations and a circuit for controlling the circuit.

The strobe signal generator 160 is configured to generate a strobe signal STROBE1 in response to an output enable signal OUT_EN1. The output enable signal OUT_EN1 is a signal which is activated during a period where the first chip 100 outputs data and is generated by the internal circuit 110. The strobe signal generator 160 includes an initial period signal generation unit 161 and an oscillator unit 162. The initial period signal generation unit 161 is configured to generate an initial period signal INITIAL1 which is activated during an initial activation period of the output enable signal OUT_EN1, and the oscillator unit 162 is configured to generate the strobe signal STROBE1 in response to the strobe signal STROBE1 and the initial period signal INITIAL1.

The oscillator unit 162 may generate the strobe signal STROBE1 using the following two methods. In a first method, the oscillator unit 162 generates the strobe signal STROBE1 in response to the output enable signal OUT_EN1. In the first method, while the initial period signal INITIAL1 is activated, the strobe signal STROBE1 is generated at a low frequency, and while the initial period signal INITIAL1 is deactivated, the strobe signal STROBE1 is generated at a high frequency. In a second method, the oscillator unit 162 also generates the strobe signal STROBE1 in response to the output enable signal OUT_EN1. In the second method, however, while the initial period signal INITIAL1 is activated, the frequency of the strobe signal STROBE1 is gradually increased, and while the initial period signal INITIAL1 is deactivated, the strobe signal STROBE1 is generated at a high frequency.

The data output circuit 120 is configured to output a data packet DATA PACKET', which the internal circuit 110 is to output to the outside, to a data pad DATA PAD. The data output circuit 120 is strobed by the strobe signal STROBE1 and outputs data of the data packet DATA PACKET1. Therefore, the data output circuit 120 outputs data at a low speed during the initial period and outputs data at a high speed after the initial period in transmitting the data packet DATA PACKET'.

The strobe input circuit 150 is configured to receive a strobe signal STROBE2 which is transmitted from the second chip 200 to the first chip 100 and transfer the received strobe signal STROBE2 to the data input circuit 130. The data input circuit 130 is strobed by the strobe signal STROBE2 and configured to receive data of a data packet DATA PACKET2 transmitted from the second chip 200 to the first chip 100.

The internal components 210, 220, 230, 240, 250, and 260 of the second chip 200 may be configured in the same manner as those of the first chip 100. Therefore, the detailed descriptions thereof are omitted herein.

FIG. 3 illustrates that when the first chip 100 outputs data, the first chip 100 generates the strobe signal STROBE1 for strobing data of the data channel DATA CHANNEL, and when the second chip 200 outputs data, the second chip 200 generates the strobe signal STROBE2 for strobing data of the data channel DATA CHANNEL. However, the embodiment of the present invention is not limited thereto. For example, when data is transmitted from the first chip 100 to the second chip 200 or transmitted from the second chip 200 to the first chip 100, the first chip 100 may generate a strobe signal for strobing data of the data channel for both chips. That is, the generation of the strobe signal may be performed by, for example, only one of the chips which transmit and receive data to and from each other.

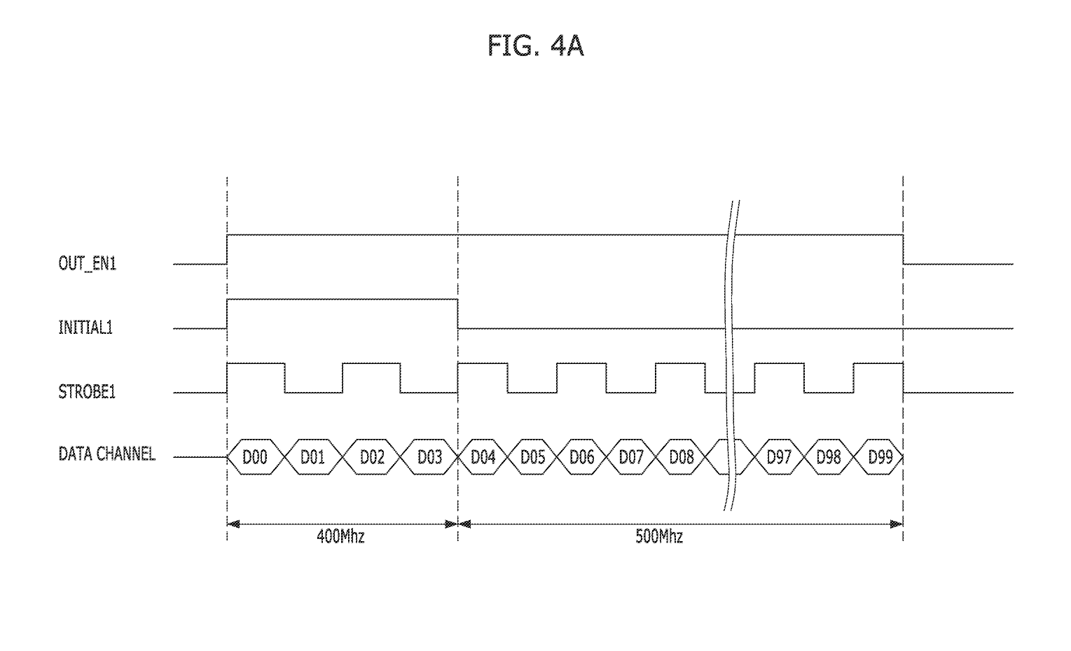

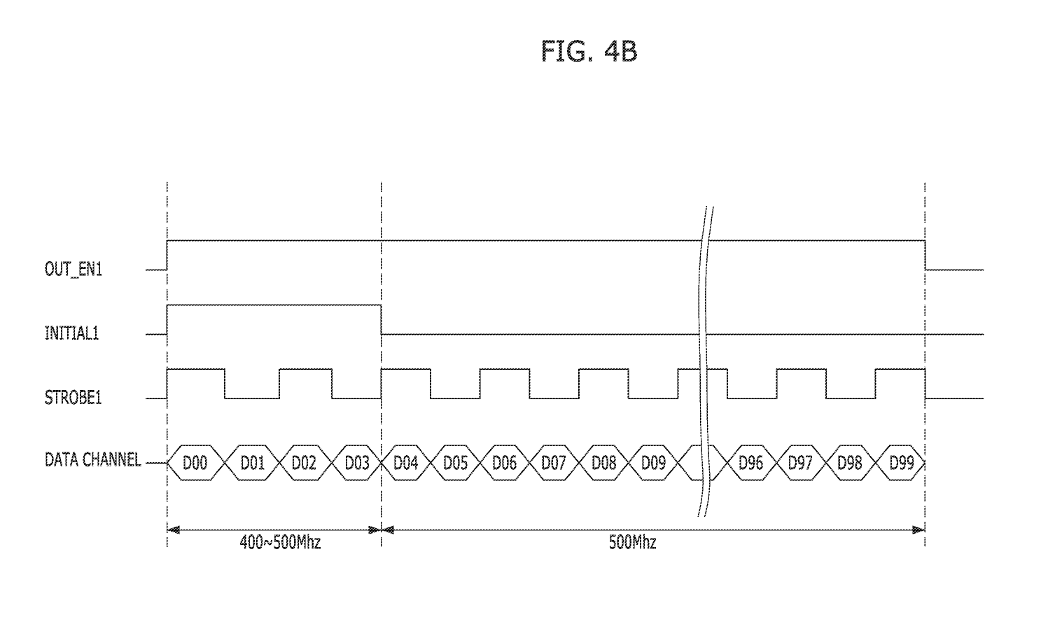

FIGS. 4A and 4B are timing diagrams for transmission of a data packet from the first chip 100 to the second chip 200 in FIGS. 2 to 3. FIG. 4A shows the transmission of the data packet according to the method of FIG. 2A, and FIG. 4B shows the transmission of data packet according to the method of FIG. 2B. Furthermore, in FIGS. 4A and 4B, it is assumed that the data packet includes 100 data.

Referring to FIG. 4A, the output enable signal OUT_EN1 is activated to a high level during a period where the data packet DATA PACKET1 is outputted from the first chip 100. Furthermore, the initial period signal INITIAL1 is activated to a high level during an initial activation period of the output enable signal OUT_EN. Here, the strobe signal STROBE1 toggles at 200 MHz while the initial period signal INITIAL1 is activated and toggles at 250 MHz while the initial period signal INITIAL1 is deactivated. The data output circuit 120 of the first chip 100 outputs data of the data packet D00 to D99 in response to the strobe signal STROBE1 Four data D00 to D03 outputted during the initial period are outputted at high and low edges of the strobe signal STROBE1 toggling at 200 MHz. That is, the four data DOD to D03 are outputted at a speed of 400 MHz, during the initial period. Furthermore, since the other data D04 to D99 are outputted at high and low edges of the strobe signal STROBE1 toggling at 250 MHz after the initial period, the data are outputted at a speed of 500 MHz. The data input circuit 230 of the second chip 200 receives the data packet D00 to D99 in response to the strobe signal STROBE1.

Referring to FIG. 4B, the output enable signal OUT_EN1 is activated to a high level during a period that the data packet DATA PACKET1 is outputted from the first chip 100. Furthermore, the initial period signal INITIAL1 is activated to a high level during an initial activation period of the output enable signal OUT_EN. Here, the strobe signal STROBE1 toggles at a frequency which is gradually increased from 200 MHz to 250 MHz, while the initial period signal INITIAL1 is activated, and toggles at 250 MHz while the initial period signal INITIAL1 is deactivated. The data output circuit 120 of the first chip 100 outputs data of the data packet DU0 to D99 in response to the strobe signal STROBE1 During the initial period, four data D00 to D03 are outputted at high and low periods of the strobe signal STROBE1 toggling at a frequency which is gradually increased from 200 MHz to 250 MHz. That is, the four data D00 to D03 are outputted at a speed which gradually increases from 400 MHz to 500 MHz during the initial period. Furthermore, since the other data D04 to D99 are outputted at high and low periods of the strobe signal STROBE1 toggling at 250 MHz after the initial period, the data are outputted at a speed of 500 MHz after the initial period. The data input circuit 230 of the second chip 200 receives the data packet DU0 to D99 in response to the strobe signal STROBE1

In accordance with the embodiments of the present invention, partial data of a data packet are transmitted at a low frequency during the initial period of a transmission period of the data packet, and the other data of the data packet are transmitted at a high frequency after the initial period. Therefore, occurrence of errors in the initial period is reduced.

Thus, an occurrence of a smaller “data-eye” for the initial period of data transmission is addressed, and data may be transmitted at a higher speed after the initial period. As a result, the transmission rate of data increases.

While the present invention has been described with respect to the specific embodiments, it will be apparent to those skilled in the art that various changes and modifications may be made without departing from the spirit and scope of the invention as defined in the following claims.

What is claimed is:

1. A method for transmitting a data packet, comprising:
transmitting the data packet at a first frequency during an initial period for transmitting the data packet; and
transmitting the data packet at a second frequency different from the first frequency after the initial period.

2. The method of claim 1, wherein the second frequency is higher than the first frequency.

3. The method of claim 1, wherein the first frequency gradually increases during the initial period and the second frequency is a constant frequency that remains substantially constant after the initial period.

4. The method of claim 3, wherein the constant frequency is the same frequency as the highest of the frequency used at the initial period.

5. A system comprising:
a first chip;
a second chip; and
a data channel between the first and second chips,
wherein, when a first data packet is transferred from the first chip to the second chip through the data channel, the first chip is configured to transmit the first data packet at a first frequency during an initial period of a transmission period for the first data packet and transmit the first data packet at a second frequency different from the first frequency after the initial period.

6. The system of claim 5, wherein the second frequency is higher than the first frequency.

7. The system of claim 6, wherein when a second data packet is transferred to the first chip from the second chip through the data channel, the second chip is configured to transmit the second data packet at the first frequency during an initial period of a transmission period of the second data packet and transmit the second data packet at the second frequency after the initial period.

8. The system of claim 6, further comprising a strobe channel between the first and second chips,
wherein the first chip is configured to transmit a first strobe signal having the first frequency through the strobe channel during the initial period of the transmission period of the first data packet and transmit a first strobe signal having the second frequency after the initial period.

9. The system of claim 8, wherein the first chip is configured to transmit the first data packet in response to the first strobe signal, and
the second chip is configured to receive the first data packet in response to the first strobe signal.

10. The system of claim 5, wherein the first frequency gradually increases during the initial period and the second frequency is a constant frequency that remains substantially constant after the initial period.

11. The system of claim 10, wherein the constant frequency is the same frequency as the highest frequency used at the initial period.

12. An integrated circuit chip comprising:
an internal circuit; and
a data output circuit configured to output a data packet of the internal circuit to a data pad,
wherein the data output circuit is configured to output the data packet at a first frequency during an initial period of a transmission period for the data packet and output the data packet at a second frequency different from the first frequency after the initial period.

13. The integrated circuit chip of claim 12, further comprising a strobe output circuit configured to output a strobe signal for strobing the data output circuit to a strobe pad.

14. The integrated circuit chip of claim 13, further comprising a strobe signal generator configured to generate the strobe signal at the strobe pad, wherein the strobe signal has the first frequency during an initial activation period of an output enable signal, and generate the strobe signal having the second frequency during an activation period after the initial activation period of the output enable signal in response to the output enable signal.

15. The integrated circuit chip of claim 13, further comprising:
a data receiving circuit configured to receive the data packet inputted to the data pad; and
a strobe receiving circuit configured to receive the strobe signal inputted to the strobe pad and provide the received strobe signal to the data receiving circuit.

16. The integrated circuit chip of claim 12, wherein the first frequency gradually increases during the initial period and the second frequency is a constant frequency that remains substantially constant after the initial period.

17. The integrated circuit chip of claim 16, wherein the constant frequency is the same frequency as the highest of the frequency used at the initial period.

18. The integrated circuit chip of claim 17, further comprising a strobe output circuit configured to output a strobe signal for strobing the data output circuit to a strobe pad.

19. The integrated circuit chip of claim 18, further comprising a strobe signal generator configured to generate the strobe signal having a gradually-increased frequency during an initial activation period of an output enable signal and generate the strobe signal having the constant frequency after the initial activation period of the output enable signal in response to the output enable signal.

20. The integrated circuit chip of claim 18, further comprising:
a data receiving circuit configured to receive the data packet inputted to the data pad; and
a strobe receiving circuit configured to receive the strobe signal inputted to the strobe pad and provide the received strobe signal to the data receiving circuit.
